(19) United States
(12) Patent Application Publication
(10) Pub. No.: US 2022/0143625 A1
(43) Pub. Date: May 12, 2022

(54) INTEGRATED DECANTER AND CENTRIFUGE SEPARATOR FOR THREE-PHASE SEPARATION

(71) Applicant: YMIR TECHNOLOGIES EHF., Reykjavik (IS)

(72) Inventors: Asgeir MATTHIASSON, Reykjavik (IS); Oddur INGOLFSSON, Kopavogur (IS); Sigurdur INGOLFSSON, Kopavogur (IS)

(73) Assignee: YMIR TECHNOLOGIES EHF., Reykjavik (IS)

(21) Appl. No.: 17/593,389

(22) PCT Filed: Mar. 20, 2020
(86) PCT No.: PCT/IS2020/050010

§ 371 Date: Sep. 17, 2021

(30) Foreign Application Priority Data
Mar. 20, 2019 (IS) 050259

(51) Int. Cl. B04B 1/20; B04B 1/08

(52) U.S. Cl. CPC B04B 1/20; B04B 2001/2083; B04B 2001/2066; B04B 1/08

(57) ABSTRACT

An apparatus for the separation of solid component, heavy and light density liquid components of a slurry, comprising a decanter section comprising a screw conveyor enclosed by a decanter house and a centrifuge section comprising a disc centrifuge. The centrifuge section is enclosed by a centrifuge house, the decanter section and centrifuge section are separated by an intersection comprising a stationary impeller for transmitting liquid from the decanter section to the centrifuge section. The screw conveyor, decanter house and centrifuge house are rotatable around a central axial shaft. The decanter section an axially arranged inlet and a solid material outlet, the centrifuge section comprises an axially central first liquid outlet for lighter liquid and second liquid outlets for heavier liquid. The second liquid outlets can be arranged on an end plate of the centrifuge house, with the radial distance of the second outlets from the central axis being adjustable.

### FIELD OF INVENTION

The current invention relates to equipment for three phase separation of organic and other material by means of a centrifuge and a decanter combined in one instrument.

### INTRODUCTION

The present invention is an apparatus useful for the separation of solids from aqueous solution from slurry material such as but not limited to processed organic waste. Centrifugal separation of material mixtures with components of different specific density, such as mixtures of oils and or fats with water, or such mixtures additionally containing solids are well known in the art. While the separation of two liquid phases of different specific gravity is generally achieved in disc centrifuges, three component mixtures, where one component is solid matter can in principle be achieved in a disc centrifuge with low level of solid material, and in a decanter centrifuge such mixtures may generally be separated into a liquid and solid phase.

In a decanter centrifuge, the centrifugal force pushes the solid material to the inner periphery of the decanter house from where a screw conveyor conveys said material to outlet holes, commonly peripheral to the inlet tube at the conical end of the decanter house. The liquid phase generally exits from the other end. Such individual instruments, however, generally do not achieve satisfactory separation where pure phases are to be isolated and must commonly be operated in tandem. The energy demand and instrumental strain is significant in such processes, specifically where disc centrifuges have to frequently discharge of solid material. Furthermore, to achieve optimal performance of both a centrifugal decanter and a disc centrifuge, they must be adjusted to the properties of the matter to be separated. This is a process that cannot be done during operation and requires halt of operation and demounting of instruments to be able to respond to variation in material properties of the mixtures to be separated.

### BRIEF DESCRIPTION OF FIGURES

The skilled person will understand that the drawings, described below, are for illustration purposes only. The drawings are not intended to limit the scope of the present teachings in any way.

FIG. 1 shows a cross-section view along the central axis of the apparatus.

FIG. 2 indicates material flow through the apparatus.

FIG. 3 shows an exploded view of the centrifugal disc section, including the impeller 1202, distribution disc 1204 and attachment plate 1203, and the end plate 1207 with the radially adjustable heavier liquid outlet holes 1212.

FIG. 4 indicates the material flow through the centrifugal disc housing.

FIG. 5 shows an example of the end plate of the centrifugal disc housing 1207 with arrangement for adjusting radial position of the heavier liquid outlet holes 1212.

### SUMMARY OF THE INVENTION

The current invention comprises combined the functionality of a screw conveyor decanter and that of a disc centrifuge in one instrument. These functional components form a decanter section and centrifuge section, respectively in joint but separately confining houses. From these, the decanter house encloses a screw conveyor and the centrifugal disc housing an impeller a distribution disc, stack of centrifugal discs and an end disc, The house and screw conveyor are independently rotatable, impeller is stationary and the centrifugal discs rotate with the housing. The decanter section further comprises at least one inlet which is preferably arranged stationary and axially, inside the hollow screw conveyors shaft. The inlet feeds material into the decanter house through holes on the inlet pipe and then through holes on the hollow screw conveyors shaft. A solid matter outlet is arranged at the proximal narrow end of the decanter house (proximal with respect to the inlet).

At least one stationary impeller is arranged between the decanter and the disc centrifuge house that transmits liquid there through and directs towards a distribution disc that distributes the liquid to the centrifuge discs. The centrifugal disc section comprises a heavy liquid phase outlet and a lighter liquid phase outlet. Generally and preferably, the centrifugal disc house has a conical shape with a wider diameter end adjoining the decanter house and a narrower diameter end at the liquid outlet end.

Thus, in a first aspect, the invention provides a separation apparatus for the separation of a slurry into a solid component and a liquid component, and further separates the liquid into a heavy and light density liquid components. The apparatus is suitable for various kinds of organic matter slurry such as but not limited to the processing of organic waste, production of fish meal or other animal or vegetable products.

The centrifuge section comprises a plurality of centrifugal discs and is enclosed by the centrifugal disc housing. The decanter section and centrifuge section are separated by an intersection comprising at least the above-mentioned stationary impeller, for transmitting liquid from the decanter section to the centrifuge section. The screw conveyor, decanter house and centrifuge house are rotatable around a central axis, where the decanter house and centrifuge house are fixedly joined together and rotate together, with the centrifuge discs. The decanter section comprises at least one axially arranged inlet and a solid material outlet, and the centrifuge section comprises further an axially central first liquid outlet for lighter liquid and second liquid outlets for heavier liquid.

In an advantageous embodiment, the mentioned second liquid outlets are arranged on an end plate of the centrifuge house opposite the decanter section, and configured such that the radial distance of the second liquid outlets from the central axis is adjustable, such as by, but not limited to, the exemplified constructions described below. In one embodiment the second outlet holes are arranged on plates that are slidably arranged in radially arranged sliding guides, the plates being aligned with radial slits on an end plate, such that when the plates are moved (adjusted radially) the holes move along the slits. Thus, the holes remain open for liquid to exit, but their position is adjusted radially.

In one embodiment the radial distance of the second outlets from the central axis is adjustable by means of motorized drives and is thus adjustable during operation of the separation apparatus, such as via a PLC computer that interacts with the motor drives.

In some embodiments, the screw conveyor has a cylindrical section and a conical proximal section (proximal to the axially arranged inlet) and the decanter house has a corresponding conical house section and cylindrical house section.

The solid material outlet preferably comprises a plurality of openings on the conical house section at or near its conical narrow end.

In some embodiments, the axially arranged inlet is arranged to feed material through a stationary inlet tube situated within a hollow core of the screw conveyor, the inlet tube having outlet holes allowing material to exit the inlet tube and into said hollow core that encloses coaxially the inlet tube, said hollow core having outlet holes allowing material to enter the main chamber of the decanter house.

In some embodiments the decanter house and centrifuge house are fixedly joined with a separating plate fixedly arranged in between the houses, the separating plate is configured to allow liquid feed to transfer from the decanter house to the stationary impeller, the centrifuge section further preferably comprises a distribution disc configured to receive liquid from the stationary impeller and distribute said liquid to the centrifugal discs.

It follows that in typical embodiment the decanter house and disc separator house are jointly rotatable but the screw conveyor is independently rotatable. Generally, the disc centrifuge and the central first liquid outlet tube will rotate along with the centrifuge house.

In useful embodiments, the separation apparatus has a plurality of peripheral holes or channels through the above mentioned separation plate and attachment plate holding the distribution disc, to allow solid residue that may have been transmitted with liquid from the decanter section to the centrifuge section, to be returned therethrough to the decanter house.

In some embodiments the inlet tube (which is generally stationary) of the decanter section is supported on its distal end by a trestle or other positioning support.

The rotating outlet tube (1208) of the decanter section is preferably supported by bearings (1209) that are held by a supporting structure. The screw conveyor is held by bearings (1105) at its inlet end, the bearings are typically configured in a bearing house supported by a structural frame. The distal end of the conveyor (the end inside the decanter house) is generally supported by bearings fixed to the separation plate (1111). The outlet tube (1208) of the centrifuge section is held by bearings (1209) that are preferably configured in a bearing house supported by a structural frame or support.

### DETAILED DESCRIPTION

In the following, exemplary embodiments of the invention will be described, referring to the figures. These examples are provided to provide further understanding of the invention, without limiting its scope.

In the following description, a series of steps are described. The skilled person will appreciate that unless required by the context, the order of steps is not critical for the resulting configuration and its effect. Further, it will be apparent to the skilled person that irrespective of the order of steps, the presence or absence of time delay between steps, can be present between some or all of the described steps.

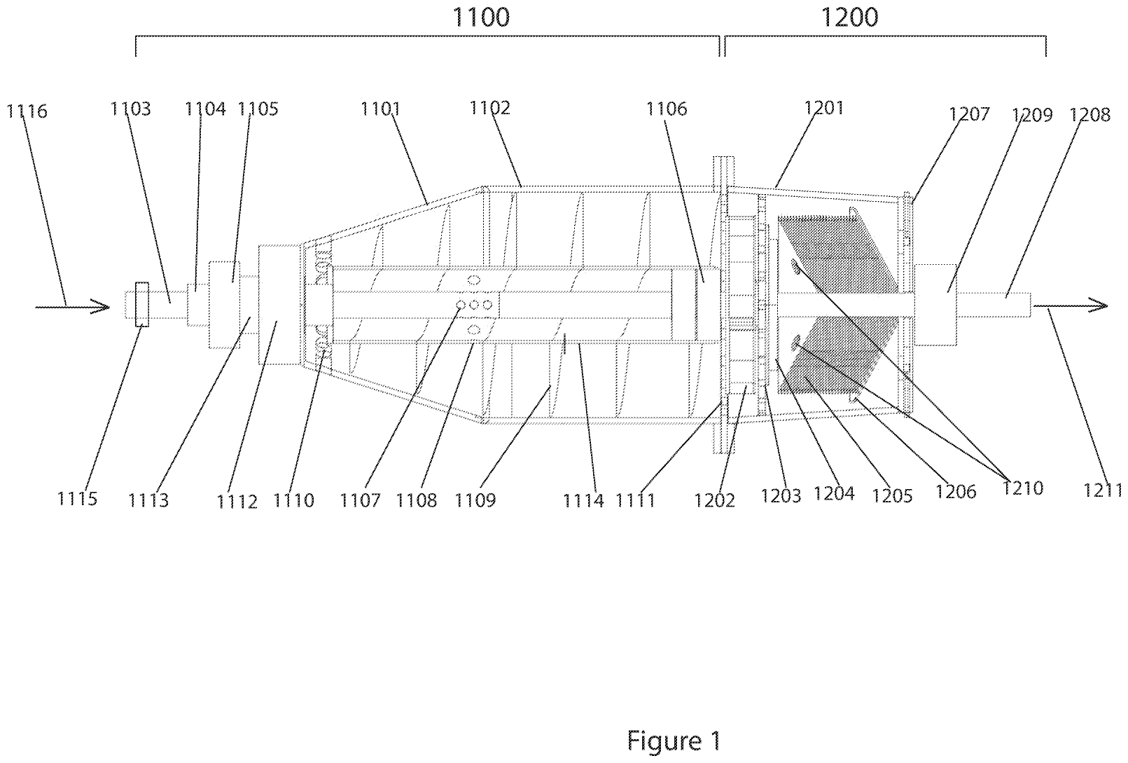

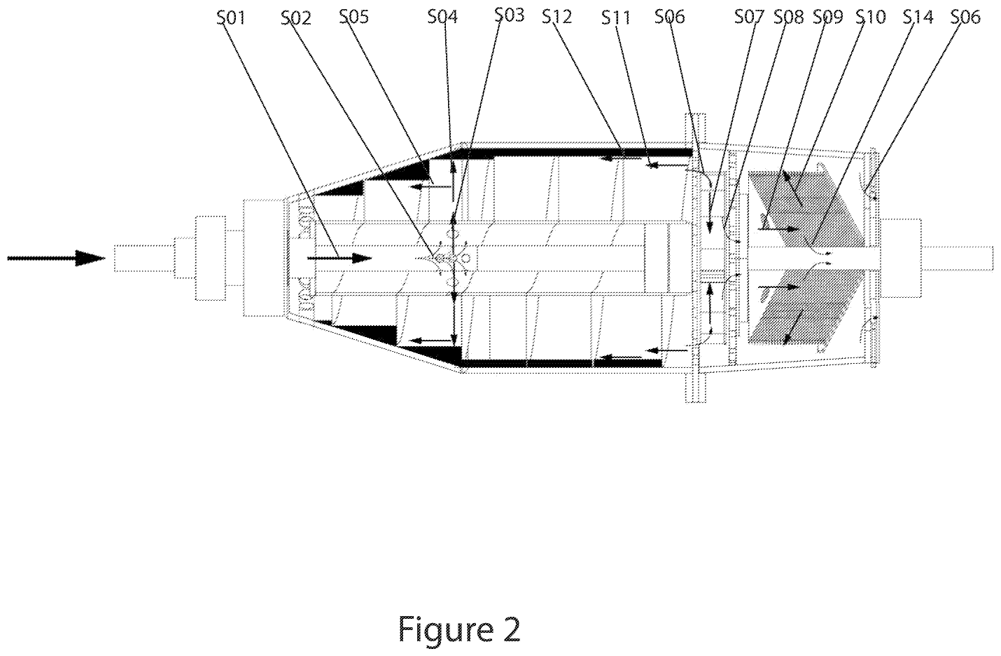

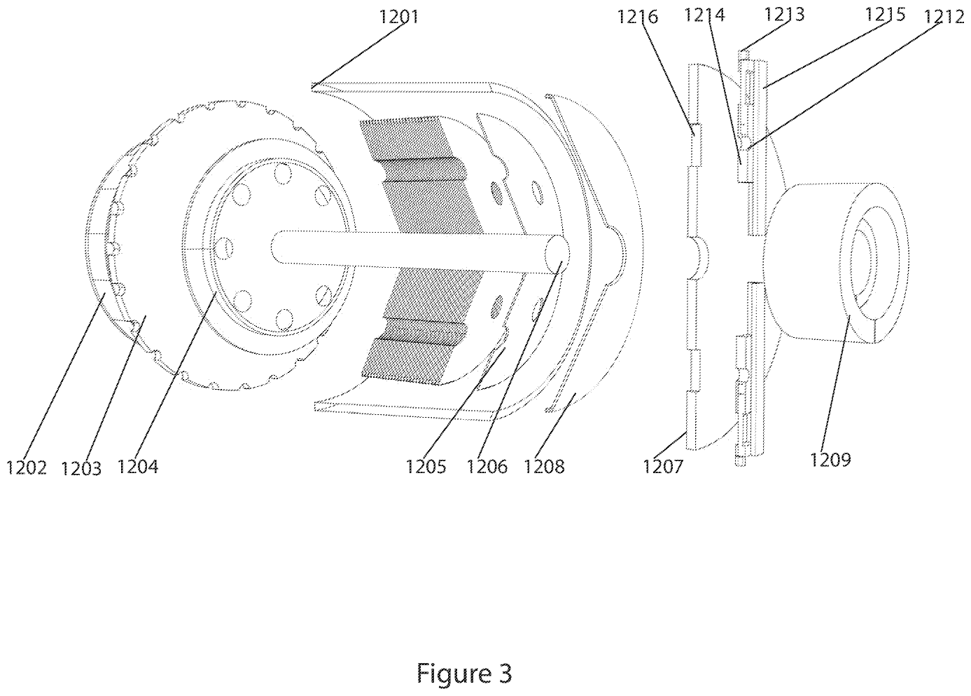

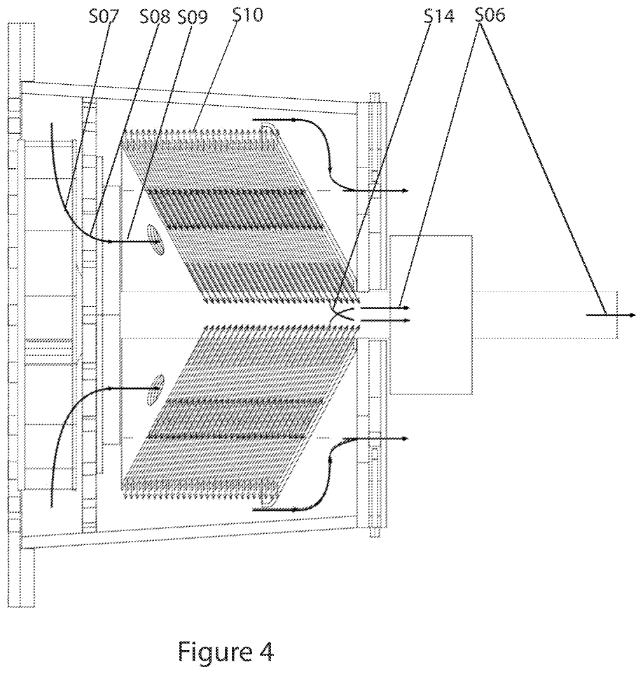

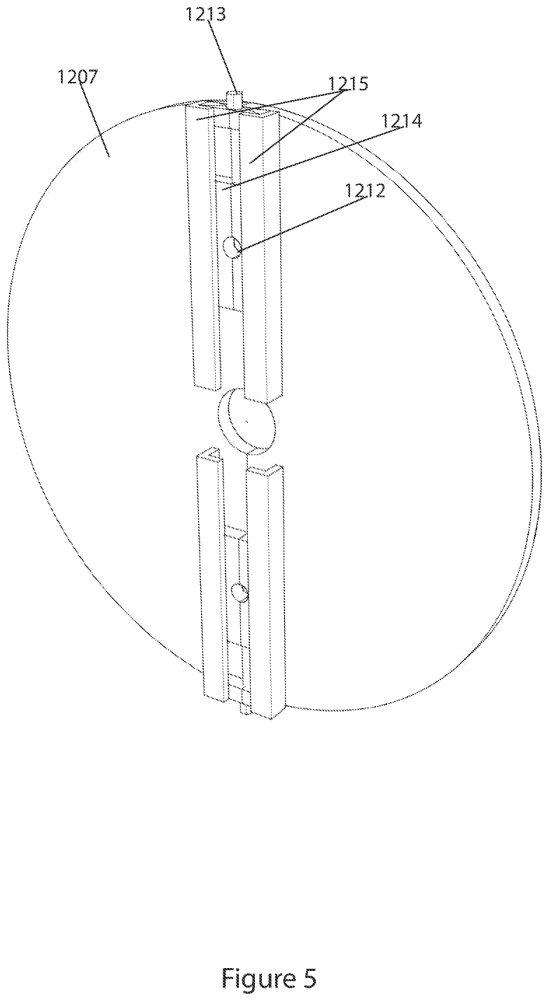

In an embodiment of the invention, shown schematically in cross sectional view in FIG. 1, the centrifugal-decanter (1000) is composed of a decanter section (1100) and a centrifugal section (1200). Material flow through the centrifugal-decanter is shown in FIG. 2. FIG. 3 shows in expanded cross sectional view of the centrifugal section (1200) and FIG. 4 shows material flow through the centrifugal section and at the junction of the decanter and centrifugal section said centrifugal decanter. FIGS. 5a and 5b illustrate an embodiment of an arrangement for adjustable (water) exit holes on the end of the disc separation house.

The centrifugal separator is comprised by two joined housings, a decanter house (1101, 1102) and a centrifugal disc house (1201), the housings held in place by bearings (1112) in the unit nave (1113) and by bearings (1209) on the bearing shaft (1208). The first section of the decanter house (1101) is conical. The cone angle (defined as the angle from central axis) of the conical section (1101) is preferably in the range from 25−35°, but may be in the range from 10 to 25° or in the range from 35 to 60° where advantageous. The conical section of the decanter house is preferably in the range about ⅕ to ⅓ of the total length of the decanter house but may be anywhere in the range from ⅔ to 1/10 of the decanter house total length, where deemed advantageous. The disc separation house (1201) is conical, preferably with a cone angle of 10 to 30°, but alternatively with a cone angle in the range from 30−45°, or 20-45° or 5-15°. The houses revolve at a rotation speed of preferably at least about 3500 to 4500 rpm, preferably rotated by a wedge belt main drive or other belt-drives or by a direct main drive or other suitable drives. The screw conveyor (1109) of the decanter section is conical along the conical section of the housing. At the inlet side of the centrifugal decanter the screw conveyor of the decanter section rests on bearings (1105) on a bearing hub (1104) and at the intersection of the decanter section with the centrifugal disc section on bearings (1106) placed between the inlet tube (1103) and the hollow core tube (1114) of the screw conveyor. In operation, the screw conveyor (1109) rotates on less speed than the conveyor house, regulated on the torch of the screw conveyor drive, and is preferably driven by an auxiliary wedge belt drive or alternatively by means of other suitable drive. The inlet pipe (1103) of the centrifugal decanter is stationary and rests on a positioning trestle (1115) or other positioning support at the inlet end and on positioning bearings (1106) inside the decanter. The inlet pipe is equipped with outlet holes (1107) for the material to enter into the screw conveyors' hollow core tube (1114) and from there through outlet holes (1108) into the screw conveyor housing. In the screw conveyor the solid material separates from the liquid by gravitational force and is conveyed through the conical section of the decanter hose to exit through holes on its end plate (1110). At the intersection there is a stationary transfer plate (1111) where the screw conveyor housing joins the centrifugal disc housing, the inlet pipe is joined to a stationary impeller (1202). The inlet pipe and the stationary impeller rest on bearings (1106). A distribution plate (1204), after the stationary impeller (1202), is fixed on a plate (1203), attached to the conical centrifugal disc housing (1201) and rotates with it. An inner tube which is part of the shaft (1208) is fixed on to the center of said plate (1203) and aligns the distribution disc (1204) a series of separation discs (1205) and a terminating end disk (1206), all attached to the shaft (1208). The distribution disc receives material from the stationary impeller and distributes said material along the stack of separation discs through the respective disc holes (1210). The lighter liquid phase separating from the heavier liquid phase on the disc surfaces (1206) accumulates in the inner tube (1208), which is perforated along the disc stack (1205). The inner tube extends outside the centrifugal decanter through the center of the end plate (1207) of the centrifugal discs housing (1201), providing an exit for the lighter liquid fraction (1211). The end plate (1207) of the centrifugal housing is provided with preferably 2 to 4 opening slits (1216), or more opening slits where advantageous. The respective slits (1216) are covered from the outside by adjustable sliding-plates (1214), provided with an exit hole (1212) aligned with the respective slits (1216). The plates are arranged in sliding profiles (1215) and are radially adjustable by means of adjustment screws (1213), preferably driven by a step motor or other motorized means (not shown). The radial distance of the outlet holes (1212) for the heavier liquid phase can thus be adjusted with respect to the center by moving the sliding-plates (1214) along the radial axis of the end-plate (1207). The radial distance of the exit-holes, can be altered from outside of the centrifugal disc hosing with manual or motor driven adjustment screws, in the later case allowing for adjusting the separation of the liquid phases during operation.

The centrifugal decanter serves to provide three-phase separation of a composition of a solid phase, a heavier liquid phase and a lighter liquid phase. These are commonly solid particles of different sizes, a water component and an oil/fat component. In the current embodiment the centrifugal decanter is specifically designed to be able to operate within a wide range of solid fractions in the subject material and to be adjustable to different feed while in operation. This applies specifically to in-operation response to changeable density of the lighter liquid phase of the feed, without jeopardizing the performance of the separator. In a preferred embodiment, where the heavier liquid phase is water, water is fed to the centrifugal decanter through the inlet (1116) of the inlet tube (1103) of the separator, before the material to be separated is fed to said separator and subjected to the separation process. The water streams into the decanter house (1101, 1102) and from there to the centrifugal housing (1201) through the stationary impeller (1202). This provides for a radial water trap, which level (radial distance from center) is defined by the adjustable holes (1212) provided at the end plate (1207) of the centrifugal disc housing (1201). Alternatively, where the subject material is rich in the heavy liquid phase, e.g., water, injection prior to injection of the subject material may be omitted. After the buildup of an adequate water trap, the subject material is fed to the centrifugal decanter, through the inlet pipe.

The subject material is pumped into the decanter centrifuge through the inlet pipe (S01, 1116), from where it flows (S02) into the core of the hollow conveyor screw axis (1114) through outlet holes (1107) on the inlet pipe. The subject material flows (S03) from the core of the hollow conveyor screw axis into the decanter house (1101, 1102) through outlets holes on said axis (1108). Due to the centrifugal force the heaviest material (dry matter, solids) (S04) is forced to the periphery of the decanter and, due to the relative speed difference between the screw conveyor of the decanter and the decanter house, the solid (dry material), is transported (S05) through the conical section of the decanter where it is compressed before exiting through the solid material outlet (1110) of the decanter section (1100). The liquid phase, on the other hand, accumulates in a hollow cylinder shape extending along the inside wall of the decanter house, and from its inner edge the liquid enters the stationary impeller peripherally (S06), where the liquid is pressed towards the impeller's center (S07) by means of the provided kinematic energy. From the center of the impeller, the liquid phase is supplied (S08) into the distribution disc (1204), from where it is distributed equally to the separation discs through their respective holes (S09, 1210). The distance of the holes from the center of the discs determines if the separation results in a pure oil fraction and a water fraction with some remaining oil (purification) or if a low fraction of water is left in the oil phase and the water phase is oil free (clarification). The separation of the liquid into a heavier phase (e.g. water) and a lighter phase (e.g. oil or fat) takes place on the surface of the separation discs and the capacity and separation rate depends on the total surface of the discs and the applied gravitational force. According to this separation principle, the heavier phase together with eventual rests of solid matter, which may have been transferred from the decanter to the centrifugal discs section, are pushed along the disc surfaces beyond the discs periphery, towards the inner boundary of the centrifugal disc housing (S10). Due to the conical shape of the centrifugal disc housing and the centrifugal forces the small amount of solid matter, that may have transferred from the decanter section, is pushed along the inner surface of the centrifugal disc housing back towards the decanter housing and enters the decanter section through small holes (S11) provided on the periphery of the plate (1203) attached to the conical centrifugal disc house and the plate separating the centrifugal disc and decanter housing (1202). Small amount of the heavy liquid phase, passes back to the decanter section along with the solid material due to the small internal leakage provided through said holes. The solid material is collected by the conveyor screw (1109) and transported (S12) towards its outlet (1110) whereas the liquid will circulate back to the centrifugal disc section via the stationery impeller (1202). The bulk of the heavier liquid phase exits the centrifugal disc hosing (S13) directly through the adjustable holes (1212) on its end plate, while the lighter phase liquid is pushed towards the center of the centrifuge discs where it enters the outlet pipe for the lighter phase (S14) at the center of the discs to exit the separator (S15).

In the current embodiment, a pressure equilibrium is established when the liquid is pumped into the centrifugal disc housing. In this equilibrium, the radial water trap prevents the lighter phase from extending into the periphery of the centrifugal disc housing and pressures it towards the center of the disc stack. The heavier liquid phase is transported towards the periphery of the disc housing, with pure heavier liquid phase passing the outer boundary of the end plate, to exit the separator (S13) through the adjustable holes on the end plate. The division/separation between light and heavy phase will depend on the difference on the special gravity of the two phases, which in turn determines the level of the water trap, that is the radial confinement of the lighter phase. For lower special gravity of the lighter phase the level of the water trap moves inward towards the center and for higher specific gravity it extends further outwards from the center. The radial distance of the adjustable exit holes for the heavier phase may in the current invention be adjusted during operation to achieve optimal separation depending on the difference in specific gravity of the two phases to be separated. This is specifically advantageous where the subject material is of variable composition, for example where such three-phase separation is operated for material, which may contain fats or oils of different density.

1. A separation apparatus for the separation of solid component, heavy and light density liquid components of an organic or other matter slurry, the apparatus comprising a decanter section (1100) comprising a screw conveyor (1109) enclosed by a decanter house (1101, 1102) and a centrifuge section (1200) comprising a disc centrifuge comprising a plurality of centrifugal discs (1205), the centrifuge section enclosed by a centrifuge house (1201), the decanter section and centrifuge section separated by an intersection comprising at least one stationary impeller (1202) for transmitting liquid from the decanter section to the centrifuge section, the screw conveyor, decanter house and centrifuge house being rotatable around a central axis, the decanter section comprising at least one axially arranged inlet (1103) and a solid material outlet (1110), the centrifuge section comprising an axially central first liquid outlet (1208) for lighter liquid and a plurality of second liquid outlets (1212) for heavier liquid.

2. The separation apparatus according to claim 1, wherein said second liquid outlets (1212) are arranged on an end plate (1207) of the centrifuge house (1201) opposite the decanter section, wherein the radial distance of the second outlets from the central axis is adjustable.

3. The separation apparatus according to claim 2, wherein the radial distance of the second outlets (1212) from the central axis is adjustable by means of motorized drives and is adjustable during operation of the separation apparatus.

4. The separation apparatus according to claim 3, wherein the radial distance of the second outlets (1212) from the central axis is adjustable by means of motorized drives and is adjustable during operation of the separation apparatus by means of a PLC or other control unit in response to the composition of at least one of the liquid phases, to optimize the performance and respond to changes in material composition.

5. The separation apparatus according to claim 2, wherein said second outlet holes (1212) are arranged on plates (1214) that are slidably arranged in radially arranged sliding guides (1215), the outlet holes being aligned with radial slits (1216) on an end plate (1207).

6. The separation apparatus according to claim 2, wherein the radial distance of the second outlet holes (1212) can be altered from outside of the centrifugal disc house with manual or motor driven adjustment screws.

7. The separation apparatus according to claim 1, wherein said decanter section has a cylindrical distal section and a conical proximal section with respect to the material inlet, and the decanter house having corresponding conical house section (1101) and cylindrical house section (1102).

8. The separation apparatus according to claim 7, wherein the solid material outlet (1110) comprises a plurality of openings on the conical house section at its narrow end.

9. The separation apparatus according to claim 1, wherein the axially arranged inlet is arranged to feed material through a stationary inlet tube (1103) situated within a hollow core (1114) of the screw conveyor, the inlet tube (1103) having outlet holes (1107) allowing material to exit the inlet tube and into said hollow core that encloses coaxially the inlet tube, said hollow core having outlet holes (1108) allowing material to enter the main chamber of the decanter house.

10. The separation apparatus according to claim 1, wherein the decanter house and centrifuge house are fixedly joined with a separating plate (1111) fixedly arranged inbetween the houses, the separating plate configured to allow liquid feed to transfer from the decanter house to the stationary impeller (1202).

11. The separation apparatus according to claim 1, further comprising a distribution disc (1204) configured to receive liquid from the stationary impeller (1202) and distribute to the centrifugal discs (1205).

12. The separation apparatus according to claim 1, wherein said decanter house and said disc separator house are jointly rotatable and said screw conveyor is independently rotatable.

13. The separation apparatus according to claim 1, wherein said centrifuge house (1201) has a conical shape with a wider diameter end adjoining the decanter house and a narrower diameter end at the liquid outlet end.

14. The separation apparatus according to claim 1, having a plurality of peripheral holes or channels through the separation plate (1111) and the attachment plate (1203) holding the distribution disc (1204), to allow solid residue to be returned therethrough to the decanter house.

15. The separation apparatus according to claim 1 wherein the stationary inlet tube (1103) is supported on its distal end by a trestle (1115) or other positioning support.

16. The separation apparatus according to claim 1 wherein the rotating bearing shaft (1208) of the centrifuge section is supported by bearings (1209) that are held by a supporting structure.

17. The separation apparatus according to claim 1, wherein the decanter house and centrifuge house are rotated by a belt drive.

18. The separation apparatus according to claim 1, wherein the decanter house and centrifuge house are rotated by a direct main drive.

19. A method for separating a solid and liquid phases from a slurry, comprising feeding the slurry through an apparatus according to claim 1 and separating into a solids phase, a lighter liquid phase and a heavier liquid phase.

20. The method according to claim 19, further comprising adjusting radial distance of exit holes for heavier liquid phase to achieve optimal separation depending on the difference in specific gravity of said two liquid phases to be separated.

21. The method according to claim 19, wherein said slurry comprises organic waste.
